(19) United States
(12) Patent Application Publication
(10) Pub. No.: US 2025/0035516 A1
(43) Pub. Date: Jan. 30, 2025

(54) DEVICE FOR DETERMINING A CONDUCTIVITY OF A TIRE

(71) Applicant: ZF Friedrichshafen AG, Friedrichshafen (DE)

(72) Inventors: Franz Zillner, Untergriesbach (DE); Andreas Griebl, Haarbach (DE); Maximilian Gell, Obernzell (DE)

(73) Assignee: ZF Friedrichshafen AG, Friedrichshafen (DE)

(21) Appl. No.: 18/716,253

(22) PCT Filed: Dec. 6, 2022
(86) PCT No.: PCT/EP2022/084624

§ 371 Date: Jun. 4, 2024

(30) Foreign Application Priority Data
Dec. 7, 2021 (DE) 10 2021 213 871.3

(51) Int. Cl. G01M 17/02; G01N 27/04

(52) U.S. Cl. CPC G01M 17/021; G01N 27/041

(57) ABSTRACT

A device is configured for determining the conductivity of a tire. The device includes a frame, a supporting device attached to the frame with a supporting surface that extends in a contact plane on which a tire can rest, a first measuring device attached to the frame and having an electrically conductive first segment, and a second measuring device attached to the frame and having an electrically conductive second segment. When a tire having a radially outer tread and a radially inner bead is resting on the supporting surface with a first side that faces toward the contact plane, the first measuring device can be moved from a second side of the tire opposite the first side to the bead so that in a test configuration the first segment contacts the bead and the second segment contacts the tread.

### RELATED APPLICATIONS

This application claims the benefit under 35 U.S.C. § 371 as a U.S. National Phase Application of application no. PCT/EP2022/084624, filed on 6 Dec. 2022, which claims the benefit of German Patent Application no. 10 2021 213 871.3, filed on 7 Dec. 2021, the contents of which are hereby incorporated herein by reference in their entireties.

### FIELD OF THE DISCLOSURE

The present invention relates to a device for determining a conductivity of a tire.

### BACKGROUND

Devices for determining a conductivity of a tire are known from the prior art. For example, the conductivity of a tire can be determined between a bead of the tire and a tread of the tire. In this case, for example, an electrically conductive section is placed against the bead and a further electrically conductive section is placed against the tread.

### SUMMARY

In general, it is desirable to build devices for determining a conductivity of a tire simply and in a material-saving manner.

It is therefore a purpose of the present invention to provide a device both simple and of material-saving design for determining a conductivity of a tire.

The objective is achieved by a device as disclosed herein. The device is designed to determine a conductivity of a tire. The device has a frame. In addition, the device comprises a supporting surface extending in a contact plane. A tire can rest on the supporting surface. The device also comprises a first measuring device. The first measuring device is attached to the frame. The first measuring device has an electrically conductive first segment. The device also has a second measuring device. The second measuring device is attached to the frame. The second measuring device has an electrically conductive second segment. The device is designed in such manner that when a tire with a tread extending radially on the outside and a bead extending radially on the inside is in contact with a first side facing toward the contact plane, the first measuring device can be moved from a second side of the tire opposite the first side of the tire to the bead, so that in a test configuration the first conductive segment and the bead are in contact and the second conductive segment and the tread are in contact.

The device is designed to determine the conductivity of a tire. Preferably, the conductivity of the tire is determined by applying an electrical voltage to the tire and measuring an electrical current strength, and from these two quantities calculating the electrical conductivity. Preferably, the device comprises a detection unit for detecting both the electrical voltage and the electrical current strength. In addition, the device preferably comprises a computer unit, which from the values determined calculates the conductivity. In the context of the present invention the term conductivity is to be understood to refer in particular to the electrical conductivity. Furthermore, in the context of the present invention the term conductivity should be understood to relate to an electrical resistance and the present invention can analogously relate to the determination of an electrical resistance of a tire. The device is designed in particular to determine the conductivity of tires with a radially outer tread surface and a radially inner bead. In particular, the tire can have two beads parallel to one another and radially on the inside. In the context of the present invention descriptions relating to a bead apply correspondingly to each bead if the tire has two beads.

The device comprises a frame. The frame can have a first section with which the frame rests on a floor surface. In addition, the frame can have a second section to which the components of the device are attached, such as the supporting device, the first measuring device and the second measuring device. Each component of the device can for example be attached directly or indirectly to the frame. Furthermore, each component of the device can for example be attached so that it can move, or so that it cannot move relative to the frame.

Moreover, the device comprises the supporting device attached to the frame. Preferably, the supporting device comprises a section which is attached directly to the frame and cannot move relative to the frame.

The supporting device comprises the supporting surface extending in the contact plane. The supporting surface extends in the contact plane. Since the supporting surface extends in the contact plane, the supporting surface has at least one section which provides a flat surface for the tire, so that the tire can also be arranged relative to the floor surface parallel to the latter.

The tire can rest on the supporting surface. In particular, the tire is not part of the device. However, the supporting surface is provided particularly so that tires whose electrical conductivity is to be checked can rest upon the supporting surface, in particular spatially and/or sequentially adjacent to one another. When the tire is resting on the supporting surface, then a first side of the tire faces toward the contact plane. A second side of the tire is opposite its first side and faces away from the contact plane, preferably in a direction contrary to the action of gravity.

The device also comprises the first measuring device. The first measuring device is attached to the frame. The first measuring device is preferably attached directly to the frame. In particular, the first measuring device is attached to an end of a robot arm which extends from its first end to a second end by which the robot arm is attached to the frame. In particular the first measuring device is attached to the frame so that it can move relative to the frame. Preferably, the robot arm can enable the first measuring device to move and approach the frame indirectly.

The first measuring device comprises the electrically conductive first segment. The first measuring device comprises at least the electrically conductive first segment. The first measuring device can also have more than one electrically conductive first segment. In the case when the first measuring device has more than one electrically conductive first segment, the first segments are preferably spatially separate from one another. Preferably, the at least one electrically conductive first segment is designed to be in contact with part of the bead of the tire, so that an electrical contact is established between the first segment and the part of the bead. In the case when more than on electrically conductive first segments are provided, then preferably for each electrically conductive first segment a corresponding part of the bead is provided so that an electrical contact is established between each electrically conductive first segment and the correspondingly associated part of the bead. In particular, in the case when more than one electrically conductive first segment is provided, the first measuring device can be designed such that at a specified point in time or during a specified time interval only one electrically conductive first segment acts together with the second measuring device to apply the electrical voltage to the tire. Likewise, preferably in the case when more than one electrically conductive first segment is provided, the first measuring device can be adapted so that at a specified point in time or during a specified time interval only one electrically conductive first segment acts together with the second measuring device to determine the electrical current strength produced by applying the electrical voltage.

The device also comprises the second measuring device. The second measuring device is attached to the frame. The second measuring device is preferably attached directly to the frame. In particular the second measuring device is attached to the frame so that it cannot move relative to the frame. The device comprises at least one second measuring device. The device can also comprise more than one second measuring device. In the case when the device comprises more than one second measuring device, the second measuring devices are preferably arranged in such manner that they are a distance apart from one another. For example, the device can have two second measuring devices, which are arranged at two opposite ends of the supporting surface Particularly preferably, two second measuring devices are arranged perpendicularly to a transport device along which the tire is moved parallel to the supporting surface. Furthermore, the two second measuring devices are arranged so that they extend away from the contact plane and in the direction of the second side of the tire, in particular perpendicularly to the contact plane.

The second measuring device comprises the electrically conductive second segment. The second measuring device and in particular each second measuring device can also have more than one electrically conductive second segment. In the case when the second measuring device has more than one electrically conductive second segment, the second segments are preferably arranged spatially separate from one another. Preferably, the at least one electrically conductive second segment is designed to be in contact with part of the tread of the tire, so that an electrically conductive contact is established between the second segment and the part of the tread. In the case when more than one electrically conductive second segment are provided, then preferably for each electrically conductive second segment a corresponding part of the tread is provided, so that between each electrically conductive second segment and the correspondingly associated part of the tread an electrically conductive contact is established. In particular it is provided that when more than one electrically conductive second segment is present, the second measuring device is designed in such manner that at a specified point in time or during a specified time interval only one electrically conductive second segment acts together with the first measuring device to apply the electrical voltage to the tire. Likewise, preferably in the case when more than one electrically conductive second segment is present, the second measuring device is designed so that at a specified point in time or during a specified time interval only one electrically conductive second segment acts together with the first measuring device to determine the electrical current strength present by virtue of the electrical voltage.

The device is designed such that when a tire with a radially outer tread and a radially inner bead rests on the supporting surface with a first side facing toward the contact plane, the first measuring device can move from a second side of the tire opposite the first side of the tire to the bead, so that in a test configuration the first conductive segment and the bead are in contact and the second conductive segment and the tread are in contact. The first measuring device can move from the second side of the tire to the bead so that contact is established between the first conductive segment and the bead, so that there is no need for further components of the first measuring device on the second side of the tire. Owing to this omission of further components of the measuring device on the second side of the tire, the device can be constructed in a material-saving and simple manner. In particular, it is provided that to reach the test configuration, in which the first conductive segment and the bead are in contact, and the second conductive segment and the tread are in contact, and in particular in order to establish these contacts, no additional components of the device have to be provided on the first side of the tire. Preferably it is provided that the device, besides the first measuring device, has no further components that can move relative to the frame except for the supporting device for moving the tire. In particular, it is provided that the device has only one first measuring device. Thus, as a whole the device has a simple structure. In particular, equipment that can be installed simply to form the supporting surface can also be used and no further structures for forming the supporting surface and for contacting the tire from the first side of the tire have to be provided.

Particularly preferably, when the first measuring device is moved from the second side of the tire to the bead the second conductive segment and the tread are not in contact. In such a case the first conductive segment and the bead, and in particular further first conductive segments and the bead can first be brought into contact, so that between the first conductive segment and a corresponding part of the bead or between each first conductive segment and a corresponding part of the bead a friction force connection is produced in each case, such that due to this force connection the tire can be moved in the direction of its second side with the help of the first measuring device. Moreover, in addition or alternatively, in such a case the first conductive segment and the bead and in particular further first conductive segments and the bead can first be brought into contact so that between the first conductive segment and a corresponding part of the bead or between each first conductive segment and a corresponding part of the bead in each case, an interlocked connection is formed, so that owing to this interlocked connection the tire can be moved in the direction of its second side with the help of the first measuring device. In particular, it is provided that between the first conductive segment and a corresponding part of the bead an interlocked connection is produced, so that by moving the first measuring device toward the second measuring device the contact between the second conductive segment and the tread can be established. Thanks to the force connection or the interlocked connection between the tire and the first measuring device, the first measuring device can additionally be moved so that with its help the electrical conductivity of the tire can be measured. In particular, the first measuring device can be used to move the tire in the direction of the second side of the tire and away from the supporting surface. Alternatively, or in addition, the first measuring device can be used to move the tire in the direction toward the second measuring device.

Alternatively preferred, when the first measuring device is moved from the second side of the tire to the bead, the second conductive segment and the tread can be in contact. In this case the test configuration can be reached by moving the first measuring device from the second side of the tire to the bead. A subsequent movement of the tire toward the second measuring device is in this case not needed, so that with the help of the device the electrical conductivity of the tire can be measured particularly time-efficiently.

In summary, it can thus be confirmed that a device with a simple and material-saving structure for determining a conductivity of a tire is provided.

In an embodiment the first measuring device comprises a number of arms which can be moved in the direction toward the contact plane, away from the contact plane and relative to one another, in particular parallel to the contact plane. In particular each of the number of arms can move relative to the frame. Each of the number of arms can in particular move relative to the others of the number of arms. In particular, relative to the other arms each arm can move in the direction toward the contact plane, away from the contact plane and parallel to the contact plane. In particular, for each arm, contact can be made between a section of the arm and a corresponding part of the bead, so that a friction-force connection and/or an interlocking connection can be made between the first measuring device and the tire, in particular between the arms of the first measuring device and the bead of the tire. In particular, the contact between the first measuring device and the tire can be made such that the tire can be moved in the direction of its second side away from the contact plane. Furthermore, the contact between the first measuring device and the tire can be made such that the tire can move toward the second measuring device, so that part of the tread of the tire can be brought into contact with the second conductive segment of the second measuring device. In particular, with the help of the number of arms it is ensured that a tire can be positioned exactly, particularly when the tire is resting on the supporting surface and/or when the tread of the tire is in contact with the second measuring device. Furthermore, after the conductivity measurement the tire can again be arranged on the supporting surface and likewise be centered and positioned exactly, so that the tire is in an optimum position for subsequent process steps and the further equipment provided for these. In particular, the positioning and the determination of the conductivity can be ensured with a comparatively simple structure. In particular, with the number of arms the tire can be centered and positioned exactly, particularly when the tire is resting on the supporting surface so that an exact positioning of the tire relative to the arms is ensured. This exact positioning also ensures that the tire can be positioned exactly relative to the second measuring device. In particular, the tire can be positioned exactly relative to the electrically conductive second segment of the second measuring device, which increases the reliability of the conductivity measurement.

In an embodiment, the electrically conductive first segment is in the form of a section of an arm of the numerous arms. When the electrically conductive first segment forms a section of an arm of the number of arms, then with the help of the first measuring device both the conductivity measurement in the tire can be carried out and also the movement of the tire with the help of the first measuring device can be ensured.

In an embodiment, each of the number of arms has an electrically conductive first segment. When each of the number of arms has an electrically conductive first segment, then the bead of the tire can be contacted at different parts, in particular parts spatially separated from one another, with the help of the electrically conductive first segment. In particular, the conductivity of the tire can be determined in various parts of the tire. Preferably, during consecutive time intervals, in each time interval an electrical voltage can be applied to another part of the tire so that in each case an electrical voltage is applied to part of the tire and an electrical current strength in that part can be determined, and from that the conductivity of the tire part concerned can be calculated. In that way the conductivity of the tire in the various parts of the tire can be determined and a conductivity profile, particularly along the running direction of the tire, can be determined. In particular, when only one second measuring device is provided this can still be done since to carry out the measurement in each part the tire is pivoted about its rotation axis. In the case when more than one second measuring device is provided, then to carry out the measurement in each part the tire can be moved in such manner that it is not pivoted about its rotation axis, but rather, moved to the second measuring devices without rotation.

In an embodiment, for each of the number of arms a second measuring device is provided, which comprises an electrically conductive second section. Particularly when each of the number of arms has an electrically conductive first section and for each arm of the numerous arms a second measuring device with an electrically conductive second section is provided, the conductivity of several parts of the tire can be determined since the tires can move to the second measuring devices one after another, in particular without being pivoted about their rotation axes, and an electrical voltage can be applied to the first and second parts opposite one another whose conductivity is to be measured, so that an electrical current strength can be determined there. In that way the conductivity of various parts of the tire can be determined in a particularly time-efficient manner.

In an embodiment, the number of arms amounts to four arms. With the help of four arms the tire can be orientated particularly exactly so that the tire is positioned particularly precisely relative to the four arms and accordingly the tire can be positioned particularly precisely relative to the second measuring device so that, in particular, reliably comparable conductivity measurements can be carried out. In particular, the four arms ensure that the results of the conductivity measurements are not falsified by wrong positioning of the tire.

In an embodiment, the supporting surface can be moved relative to the frame. When there is a tire on the supporting surface, it can be moved relative to the frame. Thus, in a simple and time-efficient manner the tire can be moved to a position in which the first measuring device can engage with the tire. The moving space of the first measuring device can in that way be kept small.

In an embodiment, the device also comprises a belt and two deflection rollers mounted to rotate, with the belt wrapped partially around them in such manner that between the deflection rollers the belt has a flat belt section which extends along the contact plane and includes the supporting surface. The use of a belt ensures that the belt section can be dimensioned appropriately for measuring the conductivity.

In an embodiment, the device comprises at least one conveyor roller, and the supporting surface is formed by a section of the outer surface of the at least one conveyor roller. The use of a conveyor roller provides a particularly low-maintenance alternative.

Further features, advantages and possible applications of the present invention emerge from the following description of example embodiments and from the figures. All the features described and/or illustrated, in their own right and in any desired combination, are included in the object of the invention even regardless of their expression in the individual claims or their back-references. Moreover, in the figures the same indexes denote the same or similar objects.

### BRIEF DESCRIPTION OF THE DRAWINGS

FIGS. 1a to 1d show a schematic representation of a view of an embodiment of a device according to the invention, seen from above.

FIG. 2 shows a schematic representation of a side view of the embodiment of the device in FIGS. 1a to 1d.

FIGS. 3 and 4 show, respectively, a schematic representation of a front view of the embodiment of the device in FIGS. 1a to 1d, and FIG. 2.

### DETAILED DESCRIPTION

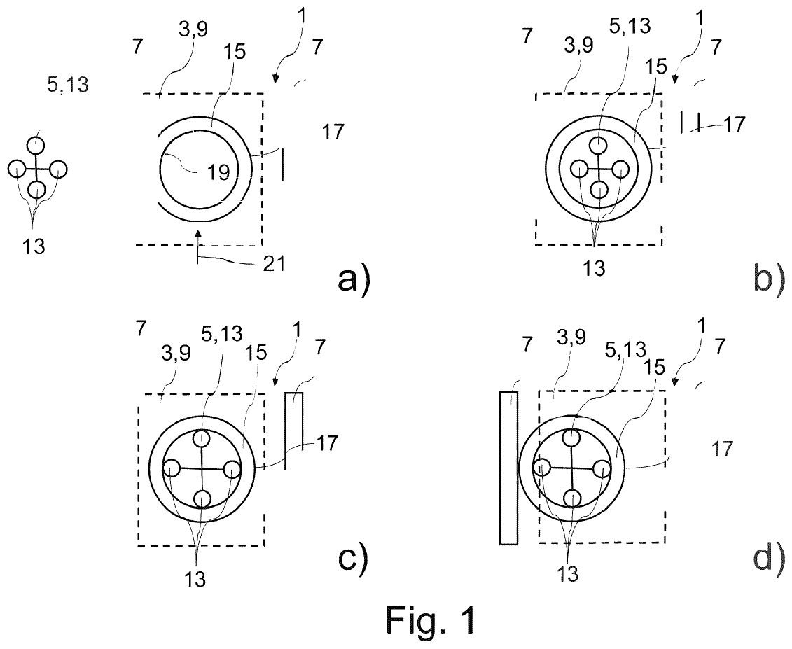

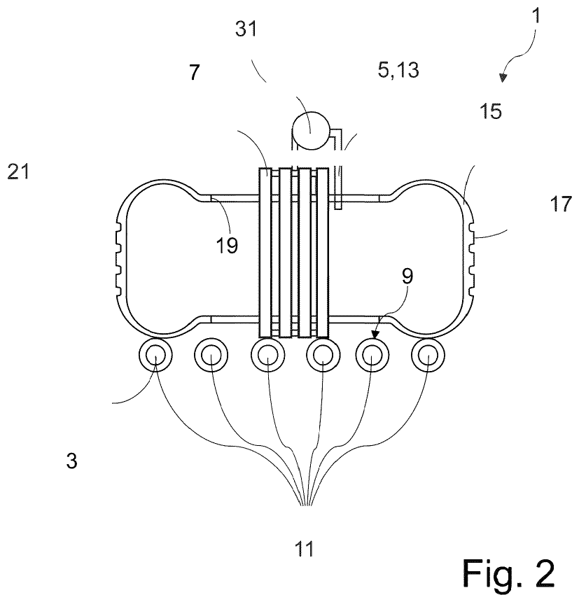

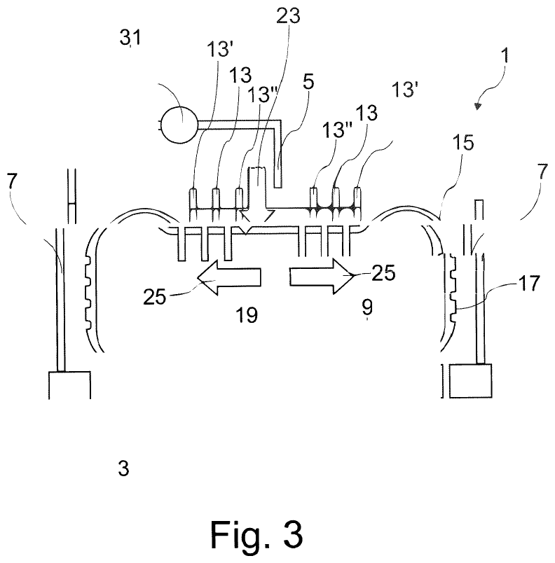

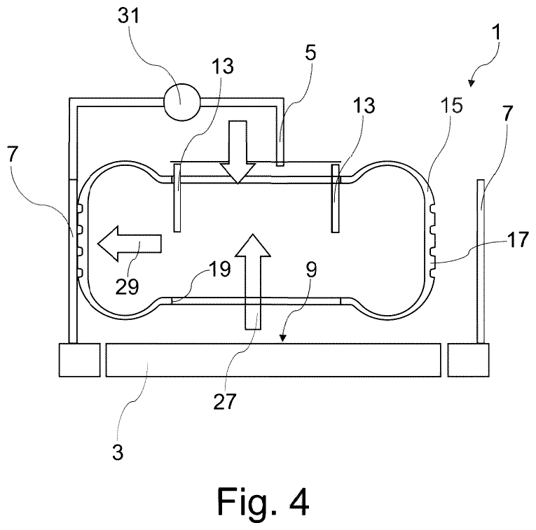

FIGS. 1a to 1d and FIG. 4 show an embodiment of a device 1 according to the invention. FIGS. 1a to 1d show a schematic representation of a view, seen from above, of the embodiment of the device 1. FIG. 2 shows a schematic representation of a side view of the embodiment of the device 1, and FIGS. 3 and 4 show a schematic representation of a front view of the embodiment of the device 1.

The device 1 has a frame, not shown in the figures. The individual components of the device 1 are attached to the frame directly or indirectly and able or not able to move relative to the frame. The device 1 has a supporting device 3, a first measuring device 5, and two second measuring devices 7. The supporting device 3, the first measuring device 5 and the second measuring devices 7 are attached to the frame. The supporting device 3 has a supporting surface 9 which extends in a contact plane. FIGS. 1a to 1d correspond to a view of the supporting surface 9 seen perpendicularly from above such that the viewing direction is orientated vertically onto the contact plane. FIGS. 2 to 4 correspond to a viewing direction parallel to the extension of the supporting surface 9 and the contact plane extends parallel to the viewing direction. The supporting surface 9 can move relative to the frame. As can be seen in FIG. 2, the device 1 has a number of conveyor rollers 11 which are attached to the frame and can rotate about a corresponding rotation axis. Each conveyor roller 11 of the conveyor rollers 11 has an outer surface which can rotate about the rotation axis, so that at any point in time some part of the outer surface in FIG. 2 is facing upward. The parts of the outer surface facing upward in FIG. 2 form the supporting surface 9. As an alternative to the conveyor rollers 11, the device 1 can comprise a belt and two rotatable deflection rollers. The belt is wrapped partially round the deflection rollers so that between the deflection rollers a flat section of the belt is formed, which extends along the contact plane and forms or comprises the supporting surface 9.

The first measuring device 5 has four arms 13. Each arm 13 of the four arms 13 can move relative to the frame. In particular, the first measuring device 5 can move relative to the frame. The first measuring device 5 can move toward the contact plane, away from the contact plane, and parallel to the contact plane. Each arm 13 can move relative to the other arms 13, i.e., the arms 13 can move relative to one another. Relative to the other arms 13, each arm 13 can move toward the contact plane, away from the contact plane, and parallel to the contact plane. The device 1 comprises two second measuring devices 7. Each second measuring device 7 is provided for a corresponding arm 13, so that for two arms 13 one second measuring device 7 is provided in each case. The device 1 illustrated here has four arms 13. However, alternatively there could also be a device 1 with two arms 13. In such a case the device 1 could also have two second measuring devices 7 so that one second measuring device 7 would be associated with each arm 13.

Each arm 13 of the four arms 13 has an electrically conductive first segment. Thus, the measuring device 5 has four electrically conductive first segments. In an alternative example, the first measuring device 5 can also have only one electrically conductive first segment. For example, four arms 13 can be provided, of which only one arm 13 of the four arms 13 has an electrically conductive first segment. Analogously, the first measuring device 5 can have two electrically conductive first segments or three electrically conductive first segments, while when four arms 13 are provided only two or only three arms 13 each have an electrically conductive first segment. Alternatively, it is also possible that a particular number of arms 13 such as four arms 13 are provided and the first measuring device 5 has an electrically conductive first segment which is not part of one of the arms 13 of the number of arms 13 concerned. For example, the first measuring device 5 can comprise an element which has the electrically conductive first segment and is designed to be moved toward the contact plane, away from the contact plane and/or parallel to the contact plane.

Each of the two second measuring devices 7 has an electrically conductive second segment. In an alternative example embodiment, the device 1 can also have only one second measuring device 7 which has an electrically conductive second segment. In that case, the device 1 provides only one electrically conductive second segment.

With the help of the four electrically conductive first segments and the two electrically conductive second segments the device 1 can determine the conductivity of a tire 15. The tire 15 has a radially external tread 17 and a radially internal bead 19. The tire rests on the supporting surface 9. Here, the tire 15 rests on the supporting surface 9 with a first side facing toward the contact plane and a second side of the tire 15 opposite the first side faces away from the contact plane and in a direction contrary to the force of gravity. In FIGS. 2, 3, and 4 the first side of the tire 15 faces downward and the second side of the tire 15 faces upward. In a test configuration each electrically conductive first segment of the four electrically conductive first segments and a corresponding part of the bead 19 are in contact. Furthermore, in the test configuration the electrically conductive second segment of the measuring device 7 shown on the left in FIGS. 3 and 4 and the tread 17 are in contact. The test configuration is shown in FIG. 1d) and FIG. 4.

To determine the electrical conductivity of the tire 15, the tire is positioned on the supporting surface 9 and moved relative to the frame in a transport device 21. This movement continues until the position shown in FIG. 1a) is reached. The next thing is that the first measuring device 5 is moved to the second side of the tire 15 so that the tire 15 is positioned between the first measuring device 5 and the supporting surface 9. The four arms 13 are positioned relative to one another in such manner that a projection of the four arms 13 on the contact plane lies within a projection of the tire 15 on the contact plane, and in this relative position relative to one another the four arms 13 can be moved in the direction of the supporting surface 9 so that they can be arranged radially inside relative to the bead 19. FIG. 1b) shows this position of the first measuring device 5 and in particular the positions of the four arms 13.

Next, the four arms 13 are moved in the direction toward the supporting surface 9. The first measuring device is therefore moved from the second side of the tire 15 toward the tire 15. This movement is represented in FIG. 3 as the first movement direction 23. When the four arms 13 are each arranged at least with a section radially inside relative to the bead 19, as shown in FIG. 3, the four arms 13 are moved relative to and away from one another and parallel to the contact plane, so that they contact the bead 19. In particular, the four arms 13 can move toward the bead 19 in such manner that a friction force connection forms between the four arms 13 and the bead 19 so that when the four arms 13 are moved in the direction away from the contact plane and toward the second side of the tire 15, the tire 15 together with the four arms 13 move toward the second side of the tire 15. The position of the four arms 13 relative to the bead 19 in which the four arms 13 and the bead 19 are in contact is shown in FIG. 1c). The movement of the four arms 13 relative to one another and in the direction of the bead 19 is represented as a second movement direction 25 in FIG. 3. Likewise, FIG. 3 shows various positions of the two arms 13 that can be seen in FIG. 3. The two arms 13 can be moved from the positions shown in FIG. 3, each in a corresponding second movement direction 25 parallel to the contact plane. The positions in which each arm 13 of the two arms 13 is in contact with the bead 19 are denoted by the index 13′ and can also be called the corresponding first position 13′ of the corresponding arm 13. The positions in which each arm 13 of the two arms 13 is arranged after the arms 13 have been moved in the direction of the contact plane, so that each arm 13 of the four arms 13 is arranged at least with a respective section radially inside relative to the bead 19 is denoted by the index 13″ and can also be called the corresponding second position of the corresponding arm 13. In FIG. 1b) each arm 13 is in its second position 13″.

Next, the tire 15 together with the four arms 13 is moved in the direction of the second side of the tire 15. The movement of the tire 15 together with the four arms 13 in the direction of the second side of the tire 15 is represented schematically in FIG. 4 by a third movement direction 27. Thus, the four arms 13 and the tire 15 are first in a position in which the four arms 13 and the tire 15 are already located a distance away from the supporting surface 9 in the direction of the first side of the tire 15, but the tread 17 of the tire 15 is not yet in contact with the electrically conductive second section of the second measuring device 7. This situation is also described by the overhead view shown in FIG. 1c).

Next, the first measuring device 5 and in particular the four arms 13 are moved parallel to the contact plane. FIG. 1d shows a position of the four arms 13 after a movement to the left in that figure. The four arms 13 are moved parallel to the contact plane until the tread 17 is in contact with the electrically conductive second segment of the second measuring device 7 shown on the left in FIG. 1d. This movement is represented in FIG. 4 by a fourth movement direction 29. The position shown in FIGS. 1d and 4, is the test configuration, in which the four electrically conductive first segments of the four arms 13 are each in contact with a respective part of the bead 19 and part of the tread 17 is in contact with the electrically conductive second segment of the second measuring device 7 shown on the left in FIGS. 1d and 4.

Thus, the device 1 is designed to move the first measuring device 5 from the second side of the tire 15 toward the bead 19 in such manner that in the test configuration both the four first conductive segments and the bead 19 and also the second conductive segment and the tread 17 are in contact.

The device 1 comprises a third measuring device 31, which is connected both to the first measuring device 5 and also to each second measuring device 7. The third measuring device 31 is designed, with the help of the first measuring device 5 and the second measuring device 7 shown on the left in FIG. 4, to apply an electrical voltage between a part of the bead 19 which is in contact with a first conductive segment of the first measuring device 5, and a part of the tread 17 which is in contact with the second conductive segment of the second measuring device 7 shown on the left in FIG. 4. In addition, the third measuring device 31 is designed to determine an electrical current strength produced by the electrical voltage applied to the tire 15. The electrical voltage applied, which can also be determined for control purposes, and the electrical current strength determined can then be used for calculating the electrical conductivity of the tire 15. This calculation can be carried out by a computer unit of the device 1. In the context of the present invention, the term conductivity should be understood to mean that in particular the electrical conductivity is being referred to. Furthermore, in the context of the present invention, the term conductivity should be understood to imply that the term can also relate to an electrical resistance and the present invention can analogously also relate to determining an electrical resistance of a tire.

The device 1 according to the invention ensures that the tire 15 can first be centered and positioned exactly, particularly when the tire 15 is resting on the supporting surface 9, and that a conductivity measurement can then be carried out. Furthermore, after the conductivity measurement the tire 15 can again be arranged on the supporting surface 9, again centered and positioned precisely, so that the tire 15 is in an optimum position for subsequent process steps and the equipment provided for the latter. In particular, the positioning and conductivity determination can be ensured using simply constructed equipment. The centering carried out first, during which the tire 15 is still on the supporting surface 9, ensures that relative to the arms 13 the tire 15 can be positioned exactly, which also ensures that the tire is positioned exactly relative to the second measuring device 7 and in particular relative to the electrically conductive segment of the second measuring device 7. It is also advantageous that the first measuring device 5 can engage in the tire 15 from the second side of the tire 15, i.e., from above in FIGS. 2, 3, and 4, since this ensures that equipment which is simple to install can be used to produce the supporting surface 9 and no further structures have to be provided on the device 1.

In addition, it should be pointed out that “comprising” does not exclude any other elements or steps, and “a” or “one” does not exclude a larger number. Furthermore, it must be pointed out that features described with reference to one of the above example embodiments can also be used in combination with other features of other example embodiments described above. Indexes in the claims are not to be regarded as restrictive.

### INDEXES

1 Device
3 Supporting device
5 First measuring device
7 Second measuring device
9 Supporting surface
11 Conveyor roller
13 Arm
13′ First position of an arm
13″ Second position of an arm
15 Tire
17 Tread
19 Bead
21 Transport device
23 First movement direction
25 Second movement direction
27 Third movement direction
29 Fourth movement direction
31 Third measuring device

1. A device (1) for determining a conductivity of a tire (15), the device (1) comprising:
a frame;
a supporting device (3) attached to the frame, with a supporting surface (9) that extends in a contact plane, on which a tire (15) can rest;
a first measuring device (5) attached to the frame, which comprises an electrically conductive first segment; and
a second measuring device (7) attached to the frame, which comprises an electrically conductive second segment;
wherein the device (1) is configured such that when a tire (15) having a radially outer tread (17) and a radially inner bead (19) rests on the supporting surface (9) with a first side facing toward the contact plane, the first measuring device (5) can be moved from a second side of the tire (15) opposite the first side to the bead (19) so that in a test configuration the first segment and the bead (19) are in contact and the second segment and the tread (17) are in contact.

2. The device (1) according to claim 1, wherein the first measuring device (5) comprises a plurality of arms (13) configured and arranged to be moved in the direction toward the contact plane, away from the contact plane, and parallel to the contact plane.

3. The device (1) according to claim 2, wherein the electrically conductive first segment forms part of an arm (13) of the plurality of arms (13).

4. The device (1) according to claim 2, wherein each arm (13) of the plurality of arms (13) has an electrically conductive first segment.

5. The device (1) according to claim 4, wherein for each arm (13) of the plurality of arms (13) the device (1) comprises a second measuring device (7), which has an electrically conductive second segment.

6. The device (1) according to claim 2, wherein the plurality of arms (13) includes four arms (13).

7. The device (1) according to claim 1, wherein the supporting surface (9) can be moved relative to the frame.

8. The device (1) according to claim 7, further comprising a belt and two rotatably mounted deflecting rollers around which the belt is partially wrapped, in such manner that between the deflecting rollers the belt forms a flat belt surface which extends along the contact plane and comprises the supporting surface (9).

9. The device (1) according to claim 7, further comprising at least one conveyor roller, wherein the supporting surface (9) is formed by a section of an outer surface of the at least one conveyor roller.

10. The device (1) according to claim 3, wherein each of the plurality of arms (13) has an electrically conductive first segment.

11. The device (1) according to claim 10, wherein each of the plurality of arms (13) comprises a second measuring device (7) having an electrically conductive second segment.

12. The device (1) according to claim 11, wherein the supporting surface (9) can be moved relative to the frame.
